(19) United States
(12) Patent Application Publication
(10) Pub. No.: US 2025/0253961 A1
(43) Pub. Date: Aug. 7, 2025

(54) INFORMATION TRANSMISSION METHOD AND APPARATUS, AND COMMUNICATION DEVICE

(71) Applicant: VIVO MOBILE COMMUNICATION CO., LTD., Guangdong (CN)

(72) Inventors: Dajie JIANG, Guangdong (CN); Jianzhi LI, Guangdong (CN); Shengli DING, Guangdong (CN)

(73) Assignee: VIVO MOBILE COMMUNICATION CO., LTD., Guangdong (CN)

(21) Appl. No.: 19/191,771

(22) Filed: Apr. 28, 2025

Related U.S. Application Data
(63) Continuation of application No. PCT/CN2023/128013, filed on Oct. 31, 2023.

(30) Foreign Application Priority Data
Nov. 8, 2022 (CN) 202211394141.7

(51) Int. Cl. H04B 17/20; H04B 17/29; H04B 17/309

(52) U.S. Cl. CPC H04B 17/253; H04B 17/296; H04B 17/346

(57) ABSTRACT

This application discloses an information transmission method and apparatus, and a communication device. The information transmission method in embodiments of this application includes: A first device measures a first signal to obtain a first result corresponding to each receiving unit. The receiving unit includes a receiving antenna or a receiving channel. The first signal includes at least one of a reference signal, a synchronization signal, a data signal, and a special signal. The first device sends a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

### CROSS-REFERENCE TO RELATED APPLICATIONS

This application is a continuation application of PCT International Application No. PCT/CN2023/128013 filed on Oct. 31, 2023, which claims priority to Chinese Patent Application No. 202211394141.7 filed in China on Nov. 8, 2022, which is incorporated herein by reference in its entirety.

### TECHNICAL FIELD

This application relates to the field of communication technologies, and specifically, to an information transmission method and apparatus, and a communication device.

### BACKGROUND

In a device having a plurality of receiving antennas, since a received signal on each receiving antenna is affected by random phase fluctuation, a division operation or a conjugate multiplication operation may be performed on channel state information (CSI) of two receiving antennas, to eliminate the impact of the random phase fluctuation of the plurality of receiving antennas. For example, a manner of dividing the CSI corresponding to the two receiving antennas may eliminate a random phase change of the CSI, thereby restoring some required sensing results, for example, restoring a respiratory rate of a person. However, in the manner, a signal receiving device, for example, a UE, needs to feed back CSI on each antenna to a base station. For example, the CSI may be a channel frequency domain response obtained by a receiving terminal through channel estimation, so that a signal sending device, for example, a base station, selects an optimal result after dividing the CSI of the two antennas, which greatly increases feedback overheads of the signal receiving device.

### SUMMARY

According to a first aspect, an information transmission method is provided, including:

A first device measures a first signal to obtain a first result corresponding to each receiving unit. The receiving unit includes a receiving antenna or a receiving channel. The first signal includes at least one of a reference signal, a synchronization signal, a data signal, and a special signal.

The first device sends a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

According to a second aspect, an information transmission method is provided, including:

A second device obtains a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

According to a third aspect, an information transmission apparatus is provided, applied to a first device, and including:
a first obtaining module, configured to measure a first signal to obtain a first result corresponding to each receiving unit, where the receiving unit includes a receiving antenna or a receiving channel, and the first signal includes at least one of a reference signal, a synchronization signal, a data signal, and a special signal; and
a first sending module, configured to send a first message, where the first message includes at least one first result satisfying a first condition or at least one second result satisfying a second condition, each second result is obtained by performing target operation processing on first results corresponding to two receiving units, and a target operation is a division operation or a conjugate multiplication operation.

According to a fourth aspect, an information transmission apparatus is provided, applied to a second device, and including:
a third obtaining module, configured to obtain a first message, where the first message includes at least one first result satisfying a first condition or at least one second result satisfying a second condition, each second result is obtained by performing target operation processing on first results corresponding to two receiving units, and a target operation is a division operation or a conjugate multiplication operation.

According to a fifth aspect, a terminal is provided. The terminal includes a processor and a memory. The memory stores a program or an instruction executable in the processor. The program or the instruction, when executed by the processor, implements the steps of the method described in the first aspect or the second aspect.

According to a sixth aspect, a terminal is provided, including a processor and a communication interface. The processor is configured to measure a first signal to obtain a first result corresponding to each receiving unit. The receiving unit includes a receiving antenna or a receiving channel. The first signal includes at least one of a reference signal, a synchronization signal, a data signal, and a special signal. The communication interface is configured to send a first message. The first message includes at least one first result satisfying a first condition or at least one second result satisfying a second condition. Each second result is obtained by performing target operation processing on first results corresponding to two receiving units. A target operation is a division operation or a conjugate multiplication operation. Alternatively, the communication interface is configured to obtain a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

According to a seventh aspect, a network side device is provided. The network side device includes a processor and a memory. The memory stores a program or an instruction executable in the processor. The program or the instruction, when executed by the processor, implements the steps of the method described in the first aspect or the second aspect.

According to an eighth aspect, a network side device is provided, including a processor and a communication interface. The processor is configured to measure a first signal to obtain a first result corresponding to each receiving unit. The receiving unit includes a receiving antenna or a receiving channel. The first signal includes at least one of a reference signal, a synchronization signal, a data signal, and a special signal. The communication interface is configured to send a first message. The first message includes at least one first result satisfying a first condition or at least one second result satisfying a second condition. Each second result is obtained by performing target operation processing on first results corresponding to two receiving units. A target operation is a division operation or a conjugate multiplication operation. Alternatively, the communication interface is configured to obtain a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

According to a ninth aspect, an information transmission system is provided, including a first device and a second device. The first device may be configured to perform the steps of the method described in the first aspect. The second device may be configured to perform the steps of the method described in the second aspect.

According to a tenth aspect, a readable storage medium is provided. The readable storage medium stores a program or an instruction. The program or the instruction, when executed by a processor, implements the steps of the method described in the first aspect, or implements the steps of the method described in the second aspect.

According to an eleventh aspect, a chip is provided. The chip includes a processor and a communication interface. The communication interface is coupled to the processor. The processor is configured to run a program or an instruction to implement the method described in the first aspect or implement the method described in the second aspect.

According to a twelfth aspect, a computer program/program product is provided. The computer program/program product is stored in a storage medium. The computer program/program product is executed by at least one processor to implement the steps of the method described in the first aspect, or implement the steps of the method described in the second aspect.

### BRIEF DESCRIPTION OF THE DRAWINGS

FIG. 1 is a structural diagram of a communication system to which an embodiment of this application may be applied;

FIG. 2 is a first schematic flowchart of an information transmission method according to an embodiment of this application;

FIG. 3 is a schematic diagram showing calculation of an SNR in a one-dimensional graph;

FIG. 4 is a second schematic flowchart of an information transmission method according to an embodiment of this application;

FIG. 5 is a first schematic diagram of modules of an information transmission apparatus according to an embodiment of this application;

FIG. 6 is a second schematic diagram of modules of an information transmission apparatus according to an embodiment of this application;

FIG. 7 is a structural block diagram of a communication device according to an embodiment of this application;

FIG. 8 is a structural block diagram of a terminal according to an embodiment of this application;

FIG. 9 is a first structural block diagram of a network side device according to an embodiment of this application; and

FIG. 10 is a second structural block diagram of a network side device according to an embodiment of this application.

### DETAILED DESCRIPTION

Technical solutions in embodiments of this application are clearly described below with reference to accompanying drawings in embodiments of this application. Apparently, the described embodiments are merely some rather than all embodiments of this application. All other embodiments obtained by a person of ordinary skill in the art based on embodiments of this application fall within the protection scope of this application.

Terms “first”, “second”, and the like in the specification and the claims of this application are used to distinguish between similar objects, and are not used to describe a specific order or sequence. It should be understood that the terms used in this way may be transposed where appropriate, so that embodiments of this application may be implemented in a sequence other than those illustrated or described herein. In addition, objects defined by “first” and “second” are generally of the same class and do not limit a quantity of objects. For example, one or more first objects may be arranged. In addition, “and/or” in the specification and the claims indicates at least one of connected objects, and a character “/” generally indicates an “or” relationship between associated objects.

It should be noted that, the technology described in embodiments of this application may be applied to a long term evolution (LTE)/LTE-advanced (LTE-A) system, and may be further applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. Terms “system” and “network” in embodiments of this application are usually interchangeably used, and the described technology may be applied to both the system and the radio technology mentioned above, or may be applied to another system and radio technology. A new radio (NR) system is described below as an example, and the term NR is used in most of the following description. Nevertheless, the technologies may also be applied to an application other than an application of the NR system, such as a 6th Generation (6G) communication system.

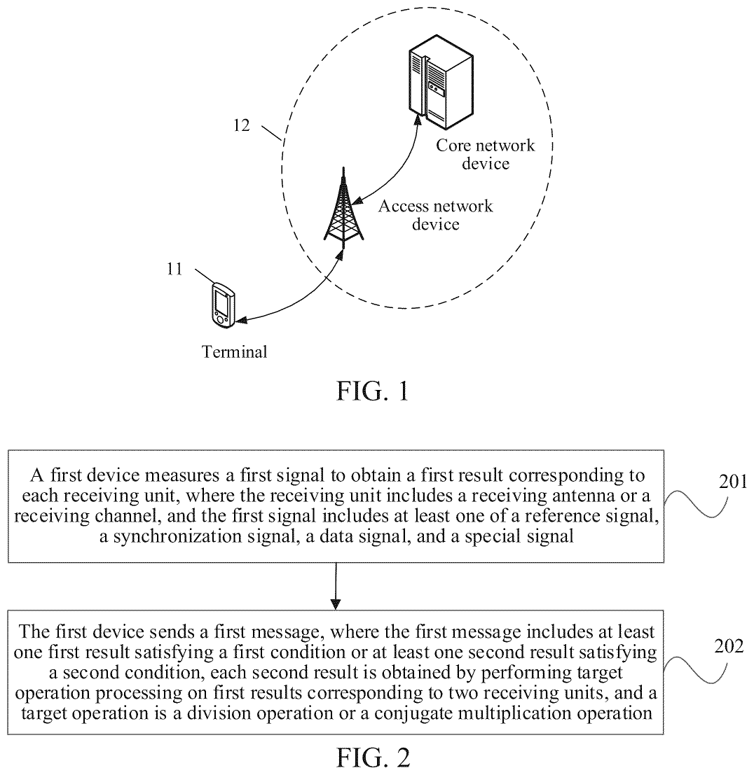

FIG. 1 is a block diagram showing a wireless communication system to which an embodiment of this application may be applied. The wireless communication system includes a user equipment 11 and a network side device 12. The terminal 11 may be a terminal side device such as a mobile phone, a tablet personal computer, a laptop computer, which is also referred to as a notebook computer, a personal digital assistant (PDA), a palm computer, a netbook, an ultra-mobile personal computer (UMPC), a mobile internet device (MID), an augmented reality (AR)/virtual reality (VR) device, a robot, a wearable device, a vehicle user equipment (VUE), a pedestrian user equipment (PUE), smart home (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. It should be noted that a specific type of the terminal 11 is not limited in embodiments of this application. The network side device 12 may include an access network device or a core network device. The access network device may also be referred to as a wireless access network device, a radio access network (RAN), a wireless access network function, or a wireless access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a household NodeB, a household evolved NodeB, a transmitting receiving point (TRP), or another appropriate term in the field, as long as the same technical effect is achieved. The base station is not limited to a specific technical term. It should be noted that, in embodiments of this application, only a base station in the NR system is used as an example, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF, or L-NEF), a binding support function (BSF), an application function (AF), and the like. It should be noted that in embodiments of this application, only a core network device in the NR system is used as an example, and a specific type of the core network device is not limited.

To enable a technical person of the art to better understand embodiments of this application, the following description is provided.

A future mobile communication system, such as a beyond 5th generation (B5G) system or a 6G system, is to have not only a communication capability but also a sensing capability. The sensing capability is an ability of one or more devices to sense information such as an orientation, a distance, or a speed of a target object or to detect, track, recognize, or form an image of a target object, an event, an environment, or the like by sending and receiving a wireless signal. With deployment of small base stations with a high bandwidth capability such as millimeter waves and terahertz in the 6G network in the future, sensing resolution is significantly improved compared with that of centimeter waves, so that the 6G network can provide more refined sensing services. Typical sensing functions and application scenarios are shown in Table 1.

TABLE 1

| Communication | | |
|---|---|---|
| and sensing | | |
| category | Sensing function | Application scenario |
| Macro sensing | Weather condition, air quality, and | Meteorology, agriculture, and |
| | the like | life services |
| | Traffic flow (intersection) and | Intelligent transportation and |
| | pedestrian flow (subway entrance) | commercial service |
| | Target tracking, ranging, speed | Numerous application scenarios |
| | measurement, contour, and the like | of conventional radar |
| | Environment reconstruction | Intelligent driving and |
| | | navigation |
| | | (automobiles/unmanned aerial |
| | | vehicles), a smart city (a three- |
| | | dimensional (3D) map), and |
| | | network planning and |
| | | optimization |
| Refined sensing | Action/posture/expression | Intelligent interaction, game, |
| | recognition | and smart home through a |
| | | smartphone |
| | Heartbeat/breathing, or the like | Health and healthcare |
| | Imaging, material detection, | Security check, industry, |
| | composition analysis, and the like | biomedicine, and the like |

Integrated sensing and communication (ISAC for short) means realizing an integrated design of communication and sensing functions through spectrum sharing and hardware sharing in a same system. During information transmission, a system can sense information such as an orientation, a distance, and a speed, and detect, track, and recognize a target object or event. A communication system and a sensing system complement each other, to realize overall performance improvement and better service experience.

Integrated radar and communication is a typical communication-sensing fused application. In the past, a radar system and a communication system were strictly distinguished from each other due to different research objects and focuses, which are researched separately in most scenarios. In fact, the radar system and the communication system are both typical information transmission, obtaining, processing, and exchange manners, and have many similarities in terms of operating principle, system architecture, and band. The integrated design of radar and communication has high feasibility, which is mainly reflected in the following aspects: First, the communication system and the sensing system are both based on the electromagnetic wave theory, which complete information obtaining and transmission through transmission and receiving of electromagnetic waves. The communication system and the sensing system both have structures such as an antenna, a transmitter end, a receiver end, and a signal processor, with significant overlapping in hardware resource. With development of technologies, an increasing overlap exists between the two in the operating band. In addition, similarities exist in key technologies such as signal modulation, receiving detection, and waveform design. The fusion of the communication system and the radar system can bring many advantages, such as reduced costs, reduced sizes, reduced power consumption, improved spectrum efficiency, and reduced mutual interference, thereby improving overall performance of the system.

Based on a difference between a sending node and a receiving node of a sensing signal, the following 6 sensing links are provided. It should be noted that for each sensing link described below, a sending node and a receiving node are used as an example. In an actual system, different sensing links may be selected based on different sensing requirements. Each sensing link may have one or more sending nodes and receiving nodes, and an actual sensing system may include a plurality of different sensing links.

1) Loop-back sensing of a base station (echo sensing through the base station). In this way, a base station sends a sensing signal and obtains a sensing result by receiving an echo of the sensing signal.

2) Radio sensing between base stations. In this case, a base station 2 receives a sensing signal sent by a base station 1 to obtain a sensing result.

3) Uplink radio sensing. In this case, a base station receives a sensing signal sent by a UE to obtain a sensing result.

4) Downlink radio sensing. In this case, a UE receives a sensing signal sent by a base station to obtain a sensing result.

5) Loop-back sensing of a terminal (echo sensing through the terminal). In this case, a UE sends a sensing signal and obtains a sensing result by receiving an echo of the sensing signal.

6) Sidelink sensing between terminals. For example, a UE 2 receives a sensing signal sent by a UE 1 to obtain a sensing result.

It should be noted that in the foregoing sensing manners, a sensing signal sending node and a sensing signal receiving node are used as an example. In an actual system, one or more different sensing manners may be selected based on different sensing cases and sensing requirements, and one or more sending nodes and receiving nodes may be provided in each sensing manner. Sensed targets may be a person and a vehicle. Assuming that neither the person nor the vehicle carries or is equipped with a signal receiving/sending device, the sensed targets in an actual scene are richer.

The first device and the second device in embodiments of this application are classified into the following five cases:
Case A: The first device is a terminal, and the second device is a base station;
Case B: The first device is a base station, and the second device is another base station;
Case C: The first device is a base station, and the second device is a core network element;
Case D: The first device is a terminal, and the second device is another terminal; and
Case E: The first device is a terminal, and the second device is a core network element.

An information transmission method provided in embodiments of this application is described below in detail through some embodiments and application scenarios thereof with reference to the accompanying drawings.

As shown in FIG. 2, an embodiment of this application provides an information transmission method, including the following steps:

Step 201: A first device measures a first signal to obtain a first result corresponding to each receiving unit. The receiving unit includes a receiving antenna or a receiving channel. The first signal includes at least one of a reference signal, a synchronization signal, a data signal, and a special signal.

Optionally, the first signal is a sensing signal. The first device may support a sensing service by receiving the first signal, for example, may obtain a sensing measurement quantity result or a sensing result by receiving a sensing signal. The sensing measurement quantity result is a measurement result corresponding to the following first measurement quantity and/or second measurement quantity. The sensing measurement quantity includes the following first measurement quantity and/or second measurement quantity.

The foregoing first signal may be a signal that does not include transmission information, such as existing LTE/NR synchronization and reference signals, including a synchronization signal block (SSB) signal, a channel state information reference signal (CSI-RS), a demodulation reference signal (DMRS), a sounding reference signal (SRS), a positioning reference signal (PRS), and a phase tracking reference signal (PTRS); or may be a special signal commonly used by a radar, such as a single frequency continuous wave (CW), a frequency modulated continuous wave (FMCW), or an ultra-wideband Gaussian pulse; and may further be a newly designed special signal with desirable correlation characteristics and a low peak-to-average power ratio, or a newly designed integrated sensing and communication signal that not only carries information but also has better sensing performance. For example, the newly designed special signal is formed by splicing/combining/superimposing at least one special sensing signal/reference signal and at least one communication signal in time domain and/or frequency domain.

Optionally, the first result corresponds to a first measurement quantity.

Optionally, the first measurement quantity (which may also be described as a first-level measurement quantity) in embodiments of this application includes at least one of the following:
a result of a frequency-domain channel response, that is, a result of a frequency-domain channel response of a receiving object. For example, the result of the frequency-domain channel response may be obtained through channel estimation. Generally, the result of the frequency-domain channel response is in a plural form;
an amplitude of the frequency-domain channel response, that is, an amplitude of the frequency-domain channel response of the receiving object;
a phase of the frequency-domain channel response, that is, a phase of the frequency-domain channel response of the receiving object;
I channel data of the frequency-domain channel response, that is, I channel data of the frequency-domain channel response of the receiving object;
Q channel data of the frequency-domain channel response, that is, Q channel data of the frequency-domain channel response of the receiving object; and
an operation result of the I channel data and the Q channel data, that is, a result of operation performed on the I channel data and the Q channel data of the frequency-domain channel response of the receiving object.

The foregoing receiving object includes a received signal or a receiving channel.

Optionally, the foregoing operation may include addition, subtraction, multiplication, division, matrix addition, subtraction, and multiplication, matrix transposition, a triangle relationship operation, a square root operation, a power operation, and the like, and a threshold detection result, a maximum/minimum value extraction result, and the like of the foregoing operation result. The operation further includes fast Fourier transform (FFT)/inverse fast Fourier transform (IFFT), discrete Fourier transform (DFT)/inverse discrete Fourier transform (IDFT), 2-dimensional FFT (2D-FFT), 3-dimensional FFT (3D-FFT), matched filtering, an autocorrelation operation, wavelet transform, digital filtering, and the like, and the threshold detection result, the maximum/minimum value extraction result, and the like of the foregoing operation result.

For example, the result of operation performed on the I channel data and the Q channel data may be determined and obtained based on I×cos(theta)+Q×sin(theta), where theta is a certain angle value, I represents the I channel data, and Q represents the Q channel data.

Optionally, the foregoing first signal is sent by a second device or by a third device other than the second device.

Step 202: The first device sends a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

Optionally, the first device sends the first message to the second device.

Each of the foregoing second results is obtained by performing a division operation or a conjugate multiplication operation on the first results corresponding to the two receiving units.

Optionally, the target operation may further be another operation other than the division operation or the conjugate multiplication operation.

For example, a frequency-domain channel response of a certain frequency resource (such as one or more subcarriers, a resource element (RE), a physical resource block (PRB), a bandwidth part (BWP), or a carrier) of a receiving antenna/receiving antenna port/receiving channel, or an amplitude of the frequency-domain channel response, or a phase of the frequency-domain channel response is obtained in a sampling period (for example, a sampling period of 20 ms) within a period of time (for example, 100 seconds). It is assumed that the receiving device obtains a frequency-domain channel response through estimation on a received time-domain signal based on a least squares method or a linear minimum mean square error (LMMSE) method. Information about variation of an amplitude of a frequency-domain channel response of a subcarrier of 2 receiving antennas with time and information about variation of a phase of the frequency-domain channel response of the subcarrier of 2 receiving antennas with time are obtained based on an actual test of the CSI-RS of a 5G system. Then, a division operation or a conjugate multiplication operation is performed on a frequency-domain channel response of a certain frequency resource (such as one or more subcarriers, an RE, a PRB, a BWP, or a carrier) of two receiving antennas/receiving antenna ports/receiving channels, or an amplitude of the frequency-domain channel response, or a phase of the frequency-domain channel response.

Optionally, the first condition includes that sensing performance corresponding to the first result satisfies a preset condition;
and/or the second condition includes at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent, for example, at least two receiving antennas in one receiving unit set are both polarized at +45 degrees, and at least two receiving antennas in another receiving unit set are both polarized at −45 degrees; and feeder lengths of the at least two receiving antennas corresponding to the second result are consistent, for example, feeder lengths of at least two receiving antennas in one receiving unit set are both less than 1 centimeter, and feeder lengths of at least two receiving antennas in another receiving unit set both range from 1 centimeter to 1.5 centimeters.

In embodiments of this application, the first device measures the first signal to obtain a first result corresponding to each receiving unit. The first device sends a first message. The first message includes at least one first result satisfying a first condition or at least one second result satisfying a second condition. Each second result is obtained by performing target operation processing on first results corresponding to two receiving units. In other words, in embodiments of this application, after the first result corresponding to each receiving unit is obtained, not all of the first results of the receiving units are reported, but the first result satisfying the second condition is reported, or the second result obtained based on the first result and satisfying the first condition is reported, so that the second device eliminates impact of the random phase fluctuations of the plurality of receiving antennas based on the second result or the first result, which greatly reduces reporting overheads of the first device.

Optionally, the method in embodiments of this application further includes:
selecting, from the first results, at least two target first results satisfying the second condition; and
performing the target operation processing on the at least two target first results, to obtain the at least one second result.

In an implementation, the first device first selects a target first result satisfying the first condition from the first results corresponding to the receiving units, then performs target operation processing on any two target first results to obtain at least one second result, and then selects a second result satisfying the second condition from at least one second result and sends the second result to the second device.

Optionally, the method in embodiments of this application further includes:

The first device obtains a second message sent by a second device, where the second message includes at least one of the following:
a parameter of the first signal;
a first measurement quantity, where the first measurement quantity is associated with the first result, that is, the first measurement quantity is a measurement quantity that the first device needs to measure based on the first signal;
the target operation being a division operation or a conjugate multiplication operation;
the first condition; and
the second condition.

Optionally, the sensing performance includes at least one of the following:
A101. A power value of a sensed target-associated signal component, for example, the power value may be a power value of a sensing path.

It should be noted that the power value of the sensed target-associated signal component is a signal component power that is greatly affected by a sensed target in the received first signal, which may be at least one of the following:

A1011. The power value is obtained through calculation by using an amplitude corresponding to a sample point having a maximum amplitude in the frequency-domain channel response of the received first signal as a target amplitude, or the power value is obtained through calculation by using an amplitude corresponding to one of a plurality of sample points having a maximum amplitude as a target amplitude. Alternatively, the power value is obtained through calculation by using an amplitude of a sample point corresponding to a certain specified subcarrier or physical resource block (PRB) as a target amplitude, or the power value is obtained through calculation by using an amplitude of a sample point corresponding to one of a plurality of specified subcarriers or PRBs as a target amplitude.

A1012. The power value is obtained through calculation by using an amplitude corresponding to a sample point having a maximum amplitude in an inverse fast Fourier transform (IFFT) result (a delay domain) of the frequency-domain channel response of the received first signal as a target amplitude, or the power value obtained through calculation by using an amplitude corresponding to one of a plurality of sample points having a maximum amplitude as a target amplitude.

Alternatively, the power value is obtained through calculation by using an amplitude corresponding to a sample point having a maximum amplitude within a specific delay range as a target amplitude, or the power value is obtained through calculation by using an amplitude corresponding to one of a plurality of sample points having a maximum amplitude as a target amplitude.

A1013. The power value is obtained through calculation by using an amplitude corresponding to a sample point having a maximum amplitude in a Fourier transform (FFT) result (Doppler domain) of the time-domain channel response of the received first signal as a target amplitude, or the power value is obtained through calculation by using an amplitude corresponding to one of a plurality of sample points having a maximum amplitude as a target amplitude.

Alternatively, the power value is obtained through calculation by using an amplitude corresponding to a sample point having a maximum amplitude within a specific Doppler range as a target amplitude, or the power value is obtained through calculation by using an amplitude corresponding to one of a plurality of sample points having a maximum amplitude as a target amplitude.

A1014. The power value is obtained through calculation by using an amplitude corresponding to a sample point having a maximum amplitude in a two-dimensional Fourier transform result, that is, a delay-Doppler domain result of a channel response of the received first signal as a target amplitude, or the power value is obtained through calculation by using an amplitude corresponding to one of a plurality of sample points having a maximum amplitude as a target amplitude.

Alternatively, the power value is obtained through calculation by using an amplitude corresponding to a sample point having a maximum amplitude within a specific delay-Doppler range as a target amplitude, or the power value is obtained through calculation by using an amplitude corresponding to one of a plurality of sample points having a maximum amplitude as a target amplitude.

It should be noted that the maximum amplitude may also be the amplitude exceeding a specific threshold value. The specific threshold value may be indicated by a network side device, or may be obtained by a terminal through calculation based on noise and/or interference power.

The specific delay/Doppler range is related to a sensing requirement, which may be indicated by a network side device, or may be obtained by a terminal based on the sensing requirement.

Radar detection is used as an example. A power value of the sensed target-associated signal component is an echo power. A method for obtaining an echo signal power may be at least one of the following options:

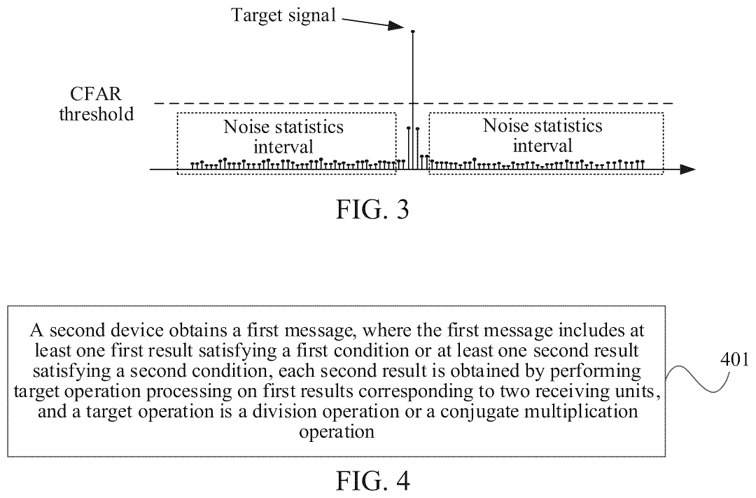

B11: Constant false alarm rate (CFAR) detection is performed on a one-dimensional delay graph obtained based on fast-time dimension FFT of the echo signal, a sample point for which the CFAR exceeds a threshold and which has a maximum amplitude is used as a target sample point, and an amplitude thereof is used as a target signal amplitude, as shown in FIG. 3.

B12: The CFAR is performed based on a Doppler one-dimensional graph obtained through slow-time dimension FFT of the echo signal, the sample point for which the CFAR exceeds the threshold and which has the maximum amplitude is used as the target sample point, and the amplitude thereof is used as the target signal amplitude, as shown in FIG. 3.

B13: The CFAR is performed based on a two-dimensional delay-Doppler graph obtained through 2D-FFT of the echo signal, the sample point for which the CFAR exceeds the threshold and which has the maximum amplitude is used as the target sample point, and the amplitude thereof is used as the target signal amplitude.

B14: The CFAR is performed based on a three-dimensional delay-Doppler-angle graph obtained through 3D-FFT of the echo signal, the sample point for which the CFAR exceeds the threshold and which has the maximum amplitude is used as the target sample point, and the amplitude thereof is used as the target signal amplitude.

It should be noted that in the method for determining the target signal amplitude, in addition to the manner of using, as the target sample point, the sample point for which the CFAR exceeds the threshold and which has the maximum amplitude, a mean value of the sample point for which the CFAR exceeds the threshold and which has the maximum amplitude and several nearest sample points of the sample point for which the CFAR exceeds the threshold is used as the target signal amplitude.

A102. A sensing signal-to-noise ratio (SNR).

For example, the sensing SNR may be a ratio of the power value of the sensed target-associated signal component to a noise power.

A103. A sensing signal-to-interference-plus-noise ratio (SINR).

For example, the sensing SINR may be a ratio of the power value of the sensed target-associated signal component to a sum of powers of noise and interference.

Specifically, a method for obtaining the SNR/SINR may be as follows.

B21: The constant false alarm rate (CFAR) detection is performed on a one-dimensional delay graph obtained through fast-time dimension FFT of the echo signal, the sample point for which the CFAR exceeds the threshold and which has the maximum amplitude is used as the target sample point, the amplitude thereof is used as the target signal amplitude, all sample points in the one-dimensional graph that are spaced apart from a position of the target sample point by ±ε or more sample points are used as interference/noise sample points, a mean interference/amplitude thereof is calculated as an interference/noise signal amplitude, and finally the SNR/SINR is calculated based on the target signal amplitude and the interference/noise signal amplitude.

B22: The CFAR is performed on a Doppler one-dimensional graph obtained through slow-time dimension FFT of the echo signal, the sample point for which the CFAR exceeds a threshold and which has a maximum amplitude is used as the target sample point, the amplitude thereof is used as the target signal amplitude, all sample points in the one-dimensional graph that are spaced apart from the position of the target sample point by ±η or more sample points are used as interference/noise sample points, a mean amplitude thereof is calculated as an interference/noise signal amplitude, and finally the SNR/SINR is calculated based on the target signal amplitude and the interference/noise signal amplitude.

B23: The CFAR is performed on a two-dimensional delay-Doppler graph obtained through 2D-FFT of the echo signal, the sample point for which the CFAR exceeds a threshold and which has a maximum amplitude is used as the target sample point, the amplitude thereof is used as the target signal amplitude, all sample points in the two-dimensional graph that are spaced apart from the target sample point by ±ε (in a fast time dimension) and ±η (in a slow time dimension) or more sample points are used as interference/noise sample points, a mean amplitude thereof is calculated as an interference/noise signal amplitude, and finally the SNR/SINR is calculated based on the target signal amplitude and the interference/noise signal amplitude.

B24: The CFAR is performed on a three-dimensional delay-Doppler-angle graph obtained through 3D-FFT of the echo signal, the sample point for which the CFAR exceeds a threshold and which has a maximum amplitude is used as the target sample point, the amplitude thereof is used as the target signal amplitude, all sample points in the three-dimensional graph that are spaced apart from the target sample point by ±ε (in a fast time dimension), ±η (in a slow time dimension), and ±δ (in an angle dimension) or more sample points are used as interference/noise sample points, a mean amplitude thereof is calculated as an interference/noise signal amplitude, and finally the SNR/SINR is calculated based on the target signal amplitude and the interference/noise signal amplitude.

It should be noted that in the manner for determining the target signal amplitude, in addition to the manner of using, as the target sample point, the sample point for which the CFAR exceeds the threshold and which has the maximum amplitude, a mean value of the sample point for which the CFAR exceeds the threshold and which has the maximum amplitude and several nearest sample points of the sample point for which the CFAR exceeds the threshold is used as the target signal amplitude.

It should be noted that a manner of determining the interference/noise sample points may further be further screening based on the above determined interference/noise sample points. The screening manner is as follows: For the one-dimensional delay graph, several sample points near a sample point with a delay of 0 are removed, and the remaining interference/noise sample points are used as noise sample points. For the one-dimensional Doppler graph, several sample points near a sample point with Doppler of 0 are removed, and the remaining interference/noise sample points are used as interference/noise sample points. For the two-dimensional delay-Doppler graph, interference/noise sample points within a strip range composed of all Doppler ranges except several points near a sample point with a delay of 0 are removed, and the remaining noise sample points are used as interference/noise sample points. For the three-dimensional delay-Doppler-angle graph, several sample points near a sample point with a time dimension of 0 and interference/noise sample points within a slice-like range composed of all Doppler ranges and all angle ranges are removed, and the remaining interference/noise sample points are used as interference/noise sample points.

A104. A presence of a sensed target, which may include at least one of the following:
a presence of a sensed target within a preset range of a speed or Doppler; and a presence of a sensed target within a preset range of a distance or a delay.

A105. A quantity of existing sensed targets, which may include at least one of the following:
a presence of a quantity of sensed targets within a preset range of a speed or Doppler; and
a presence of a quantity of sensed targets within a preset range of a distance or a delay.

It should be noted that the foregoing A104 and A105 may be notified to a terminal by another device (for example, another terminal, an access network device, or a core network device) based on a sensing requirement.

It should be noted that a manner of determining whether a sensed target exists may be as follows. For example, it is determined whether a sample point having an amplitude exceeding a specific threshold exists in a one-dimensional or two-dimensional delay/Doppler graph, and if such a sample point is present, it is considered that a sensed target is detected. A quantity of sample points with an amplitude exceeding a specific threshold in a one-dimensional or two-dimensional delay/Doppler graph is considered as a quantity of sensed targets.

A106. Information about a radar cross section (RCS) of a sensed target.

It should be noted that the RCS information may be RCS information of a single sensed target, or may be RCS information of a plurality of sensed targets.

A107. Spectral information of the sensed target.

It should be noted that the spectral information may include at least one of the following: delay power spectrum, Doppler power spectrum, delay/distance-Doppler/velocity spectrum, angle power spectrum, delay/distance-angle spectrum, Doppler/velocity-angle spectrum, and delay/distance-Doppler/velocity-angle spectrum.

A108. A delay of at least one sensed target.

A109. A distance of the at least one sensed target.

A110. Doppler of the at least one sensed target.

A111. A speed of the at least one sensed target.

A112. Angle information of the at least one sensed target.

Optionally, the sensing performance satisfying the preset condition includes at least one of the following:
the power value of the sensed target-associated signal component satisfies a first threshold, or a power value of the sensed target-associated signal component is maximum; for example, a power value of a sensed target-associated signal component corresponding to a second result (or another operation result) obtained by performing a division operation or a conjugate multiplication operation on first sensing measurement quantity results on two receiving antennas/receiving channels satisfies a first threshold;
a sensing SNR satisfies a second threshold, or the sensing SNR is maximum;
the sensing SINR satisfies a third threshold, or the sensing SINR is maximum;
at least Y sensed targets are detected;
a bitmap corresponding to a sensed target determined based on detection is consistent with a preset bitmap configured by a network side device;
the radar cross section (RCS) of the sensed target satisfies a third condition, or the RCS is maximum; for example, the radar cross section (RCS) of the sensed target satisfies a third condition, optionally, the third condition is that the RCS reaches X square meters, where X is a positive real number;
the spectral information of the sensed target satisfies a fourth condition, for example, the spectral information of the sensed target satisfies a fourth condition; for example, a distance-velocity spectrum of a sensed target satisfies the fourth condition, and in this case, the fourth condition is that a sensed target can be distinguished from the distance-velocity spectrum (an amplitude of a point or a region in the distance-velocity spectrum reaches a preset value or has a maximum amplitude); or a delay-Doppler spectrum of a sensed target satisfies the fourth condition, and in this case, the fourth condition is that a sensed target can be distinguished from the delay-Doppler spectrum (an amplitude of a point or a region in the delay-Doppler spectrum reaches a preset value or has a maximum amplitude);
a first parameter of the sensed target satisfies a fifth condition, where the first parameter includes at least one of the following: delay, distance, Doppler, speed, and angle information; for example, a delay of the sensed target satisfies the fifth condition (for example, the delay satisfies an interval value); for another example, a distance of the sensed target satisfies the fifth condition (for example, the distance satisfies an interval value); for another example, Doppler of the sensed target satisfies the fifth condition (for example, the Doppler satisfies an interval value); for another example, a speed of the sensed target satisfies the fifth condition (for example, the speed satisfies an interval value); and for another example, angle information of the sensed target satisfies the fifth condition (for example, the angle information satisfies an interval value),
where Y is a positive integer.

Optionally, the parameter (or parameter configuration information) of the first signal includes at least one of the following:

First item: A waveform type, for example, an orthogonal frequency division multiplexing (OFDM) waveform, a single-carrier frequency-division multiple access (SC-FDMA) waveform, an orthogonal time frequency space (OTFS) waveform, a frequency modulated continuous wave (FMCW) waveform, or a pulse signal waveform.

Second item: A subcarrier interval: For example, the subcarrier interval is a subcarrier interval of an OFDM system is 30 KHz.

Third item: A guard interval: The guard interval is a time interval between a sending moment of a signal ends and a moment a latest echo signal of the signal is received. The parameter is directly proportional to a maximum sensing distance, which may be for example calculated through 2dₘₐₓ/c, where dₘₐₓ is a maximum sensing distance (which is a sensing requirement). For example, for a loop-back target signal, dₘₐₓ represents a maximum distance between a target signal reception-transmission point and a signal transmission point. In some cases, a cyclic prefix CP of an OFDM signal may play a role of a minimum guard interval.

Fourth item: A bandwidth: The parameter is inversely proportional to a distance resolution, and may be obtained through c/(2Δd), where Δd is a distance resolution (which is a sensing requirement), and c is a speed of light.

Fifth item: A burst duration: The parameter is inversely proportional to a speed resolution (which is a sensing requirement). The parameter is a time span of a target signal, which is mainly used for calculating a Doppler frequency shift. The parameter may be calculated through c/(2f_{c}Δv), where Δv is a speed resolution, and f_{c} is a carrier frequency of a target signal.

Sixth item: A time domain interval: The parameter may be calculated through c/(2f_{c}v_{range}), where v_{range} is a maximum speed minus a minimum speed (which is a sensing requirement). The parameter is a time interval between two adjacent target signals.

Seventh item: A signal sending power, for example, a value taken every 2 dBm from −20 dBm to 23 dBm.

Eighth item: A signal format, such as a sounding reference signal (SRS), a demodulation reference signal (DMRS), a positioning reference signal (PRS), or another predefined signal, and information such as a related sequence format.

Ninth item: A signal direction, for example, a direction of a target signal or beam information.

Tenth item: A time resource, for example, a slot index where a target signal is located or a symbol index of a slot. Time resources are divided into two types. One type is a disposable time resource, for example, an omnidirectional target signal is sent with a symbol. The other type is a non-disposable time resource, for example, a plurality of groups of periodic time resources or discontinuous time resources (which may include a start time and an end time). Each group of periodic time resources send target signals in a same direction, and beam directions of different groups of periodic time resources are different.

Eleventh item: A frequency resource, including a center frequency of a target signal, a bandwidth, a resource block (RB), a subcarrier, Point A, an initial bandwidth position, or the like.

Twelfth item: A quasi co-location (QCL) relationship. For example, a target signal includes a plurality of resources, and each resource is quasi co-located (QCLed) to an SSB, where the QCL includes Type A, B, C, or D.

Thirteenth item: Antenna configuration information of a sensing node (a base station or a UE).

Optionally, the antenna configuration information of the sensing node (the base station or the UE) includes at least one of the following:
an antenna array element identifier (ID) or an antenna port ID for sending and/or receiving a target signal;
an antenna panel ID+an array element ID for sending and/or receiving a target signal;
location information (which may be represented by Cartesian coordinates (x, y, z) or spherical coordinates (ρ, φ, θ)) of an antenna array element for sending and/or receiving a target signal relative to a local reference point on an antenna array; and
location information (which may be represented by Cartesian coordinates (x, y, z) or spherical coordinates (ρ, φ, θ)) of a panel for sending and/or receiving a target signal relative to a local reference point on an antenna array, and location information (which may be represented by Cartesian coordinates (x, y, z) or spherical coordinates (ρ, φ, θ)) of antenna array elements in these selected panels for sending a target signal relative to a certain unified reference point of the panel (for example, a central point of the panel).

Fourteenth item: Bitmap information of an antenna array element. For example, in the bitmap, “1” is used for indicating that an array element is selected to send and/or receive a target signal, and “0” is used for indicating that an array element is not selected (or vice versa).

Fifteenth item: Bitmap information of an array panel, for example, in the bitmap, “1” is used for indicating that a panel is selected to send and/or receive a target signal, and “0” is used for indicating that an array element is not selected (or vice versa); and bitmap information of the array element in these selected panels.

Sixteenth item: Threshold information, that is, a threshold for determining, by at least any one of a source node, a first device, and a candidate node, whether the obtained sensing measurement quantity measurement value satisfies a first condition. The threshold may be different for different candidate nodes and/or candidate tags. For any candidate node and/or candidate tag, a sensing measurement quantity and a corresponding threshold thereof may be greater than 1. The first condition is that a corresponding candidate node/candidate tag for obtaining the sensing measurement quantity measurement value may be used as a target node/target tag.

Optionally, the first message further includes at least one of the following:
a third result corresponding to a second measurement quantity obtained based on the second result;
a fourth result corresponding to a second measurement quantity obtained based on the first result;
label information corresponding to the first result;
label information corresponding to the second result;
label information corresponding to the third result; and
label information corresponding to the fourth result.

Herein, the first device sends the label information corresponding to the first result, the second result, the third result, or the fourth result above to a second device, so that the second device can learn the label information corresponding to the first result, the second result, the third result, or the fourth result.

Optionally, the second measurement quantity includes at least one of the following:
a delay of a sensed target;
Doppler of the sensed target;
angle information of the sensed target;
strength of a sensing signal;
a distance of the sensed target;
a speed of the sensed target;
an orientation of the sensed target;
a spatial position of the sensed target;
an acceleration of the sensed target;
a presence of a sensed target;
at least one of trajectories, actions, expressions, vital signs, a quantity, and imaging results of sensed targets;
weather information;
air quality; and
at least one of a shape, a material, and an ingredient of the sensed target.

In embodiments of this application, the foregoing second measurement quantity is classified as follows:
a second-level measurement quantity, where the second-level measurement quantity includes at least one of the following: delay of a sensed target, Doppler of the sensed target, angle of the sensed target, and strength of a sensing signal, and the second-level measurement quantity may be regarded as a basic measurement quantity.

A third-level measurement quantity, where the third-level measurement quantity includes at least one of the following: a distance of the sensed target, a speed of the sensed target, an orientation of the sensed target, a spatial position of the sensed target, and an acceleration of the sensed target. The third-level measurement quantity may be regarded as a basic attribute/state of the sensed target.

A fourth-level measurement quantity (an advanced attribute/state) includes: a presence of a sensed target, and trajectories, actions, expressions, vital signs, a quantity, imaging results, weather, air quality, shapes, materials, and ingredients of the sensed target.

Optionally, the label information includes at least one of the following:
sensing signal identification information;
sensing measurement configuration identification information;
sensing service information (for example, a sensing service ID);
data subscription ID information;
measurement quantity usage information, for example, used for communication, sensing, or communication and sensing;
time information;
sensing node information, for example, a UE ID, a node location, and a device orientation;
sensing link information, for example, a sensing link sequence number or a transceiver node identifier, and for another example, an identifier of a receiving antenna or a receiving channel, where if the sensing link information is a sensing measurement quantity of a single receiving antenna or receiving channel, the identifier is an identifier of the receiving antenna or the receiving channel; and if the sensing link information is a result of division or conjugate multiplication of two receiving antennas or receiving channels, the identifier is an identifier of the two receiving antennas or receiving channels, and an identifier of division or conjugate multiplication;
measurement quantity description information, for example, an amplitude value, a phase value, and a complex value of a combination of an amplitude and a phase; a resource type, for example, a time-domain measurement result or a frequency-domain resource measurement result; and measurement quantity indicator information, for example, an SNR or a sensing SNR.

In an embodiment of this application, the information transmission method includes the following steps:

Step 1: A first device receives a second message sent by a second device, where the second message includes at least one of the following:

a parameter of the first signal;
a first measurement quantity;
a target operation being a division operation or a conjugate multiplication operation; and
a first condition.

Step 2: The first device measures a first signal to obtain a first result on each receiving unit, where the first signal is sent by the second device or another device.

Step 3: The first device processes the first results corresponding to at least two receiving units based on the target operation, to obtain at least one second result, and sends the first message, where the first message includes the second result satisfying a second condition.

Optionally, the first message further includes at least one of the following: a third result corresponding to a second measurement quantity obtained based on the second result;
a fourth result corresponding to a second measurement quantity obtained based on the first result;
label information corresponding to the first result;
label information corresponding to the second result;
label information corresponding to the third result; and
label information corresponding to the fourth result.

Step 4: The second device obtains a sensing result (such as a respiratory rate of a person) based on the second result in the first message, or sends the first message to another device, where the another device obtains a sensing result based on the second result in the first message.

In an embodiment of this application, the information transmission method includes the following steps:

Step 1: A first device receives a second message sent by a second device, where the second message includes at least one of the following:
a parameter of the first signal;
a first measurement quantity; and
a first condition.

Step 2: The first device measures a first signal to obtain a first result on each receiving unit, where the first signal is sent by the second device or another device.

Step 3: The first device sends a first message to the second device, where the first message satisfies at least one first result of the first condition.

Optionally, the first message further includes at least one of the following: a third result corresponding to a second measurement quantity obtained based on the second result;
a fourth result corresponding to a second measurement quantity obtained based on the first result;
label information corresponding to the first result;
label information corresponding to the second result;
label information corresponding to the third result; and
label information corresponding to the fourth result.

Step 4: The second device performs a target operation on at least two first results to obtain a second result, and obtains a sensing result based on the second result; or the second device sends the first message to another device, and the another device obtains a sensing result based on the first result.

Optionally, the sensing result mentioned in embodiments of this application includes at least one of the following:
a shape of a sensed target, a contour of the sensed target, a presence of the sensed target, a trajectory of the sensed target, an action of the sensed target, an expression of the sensed target, a vital sign of the sensed target, a quantity of sensed targets, an imaging result of the sensed target, weather, air quality, a material of the sensed target, an ingredient of the sensed target, a gesture of the sensed target, a respiratory rate of the sensed target, a heartbeat frequency of the sensed target, and sleep quality of the sensed target.

In embodiments of this application, the first device measures the first signal to obtain a first result corresponding to each receiving unit. The first device sends a first message. The first message includes at least one first result satisfying a first condition or at least one second result satisfying a second condition. Each second result is obtained by performing target operation processing on first results corresponding to two receiving units. In other words, in embodiments of this application, after the first result corresponding to each receiving unit is obtained, not all of the first results of the receiving units are reported, but the first result satisfying the second condition is reported, or the second result obtained based on the first result and satisfying the first condition is reported, so that the second device eliminates impact of the random phase fluctuations of the plurality of receiving antennas based on the second result or the first result, which greatly reduces reporting overheads of the first device.

As shown in FIG. 4, an embodiment of this application further provides an information transmission method, including the following steps:

Step 401: A second device obtains a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

Optionally, the first condition includes that sensing performance corresponding to the first result satisfies a preset condition;
and/or the second condition includes at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent, for example, at least two receiving antennas in one receiving unit set are both polarized at +45 degrees, and at least two receiving antennas in another receiving unit set are both polarized at −45 degrees; and
feeder lengths of the at least two receiving antennas corresponding to the second result are consistent, for example, feeder lengths of at least two receiving antennas in one receiving unit set are both less than 1 centimeter, and feeder lengths of at least two receiving antennas in another receiving unit set both range from 1 centimeter to 1.5 centimeters.

In embodiments of this application, the second device obtains a first message. The first message includes at least one first result satisfying a first condition or at least one second result satisfying a second condition. Each second result is obtained by performing target operation processing on first results corresponding to two receiving units. A target operation is a division operation or a conjugate multiplication operation. In other words, in embodiments of this application, the second device only obtains at least one first result satisfying a first condition or at least one second result satisfying a second condition, rather than obtaining the first result or the second result of each receiving unit, thereby greatly reducing reporting overheads of the first device.

Optionally, the method in embodiments of this application further includes:
The second device obtains a sensing result based on the first message,
or the second device sends the first message to a third device.

Herein, the second device sends the first message to the third device, so that the third device obtains a sensing result based on the first message.

Optionally, that the second device obtains the sensing result based on the first message includes:
the second device performs the target operation processing on at least two first results in the first message, to obtain at least one second result; and
obtains a sensing result based on the second result.

Optionally, the sensing result mentioned in embodiments of this application includes at least one of the following:
a shape of a sensed target, a contour of the sensed target, a presence of the sensed target, a trajectory of the sensed target, an action of the sensed target, an expression of the sensed target, a vital sign of the sensed target, a quantity of sensed targets, an imaging result of the sensed target, weather, air quality, a material of the sensed target, an ingredient of the sensed target, a gesture of the sensed target, a respiratory rate of the sensed target, a heartbeat frequency of the sensed target, and sleep quality of the sensed target.

Optionally, the method in embodiments of this application further includes:

The second device sends a second message.

The second message includes at least one of the following:
a parameter of the first signal;
a first measurement quantity, where the first measurement quantity is associated with the first result;
a target operation being a division operation or a conjugate multiplication operation;
a first condition; and
a second condition.

Optionally, in a case that the foregoing second message includes the target operation being the division operation or the conjugate multiplication operation, the first device processes the first results corresponding to at least two receiving units, to obtain at least one second result. The foregoing first message includes a second result satisfying the second condition. In a case that the foregoing second message does not include the target operation being the division operation or the conjugate multiplication operation, the first device sends the first message, where the first message includes the first result satisfying the first condition, and the second device processes the first results corresponding to at least two receiving units to obtain at least one second result.

In embodiments of this application, the second device obtains a first message. The first message includes at least one first result satisfying a first condition or at least one second result satisfying a second condition. The second device obtains a sensing result based on the second message, or the second device sends the second message to another device (for example, a third device), so that the another device obtains the sensing result. Each second result is obtained by performing target operation processing on first results corresponding to two receiving units. A target operation is a division operation or a conjugate multiplication operation. In other words, in embodiments of this application, the second device only obtains at least one first result satisfying a first condition or at least one second result satisfying a second condition, rather than obtaining the first result or the second result of each receiving unit, thereby greatly reducing reporting overheads of the first device.

The information transmission method provided in embodiments of this application may be performed by an information transmission apparatus. In embodiments of this application, the information transmission apparatus provided in embodiments of this application is described by using an example in which the information transmission apparatus performs the information transmission method.

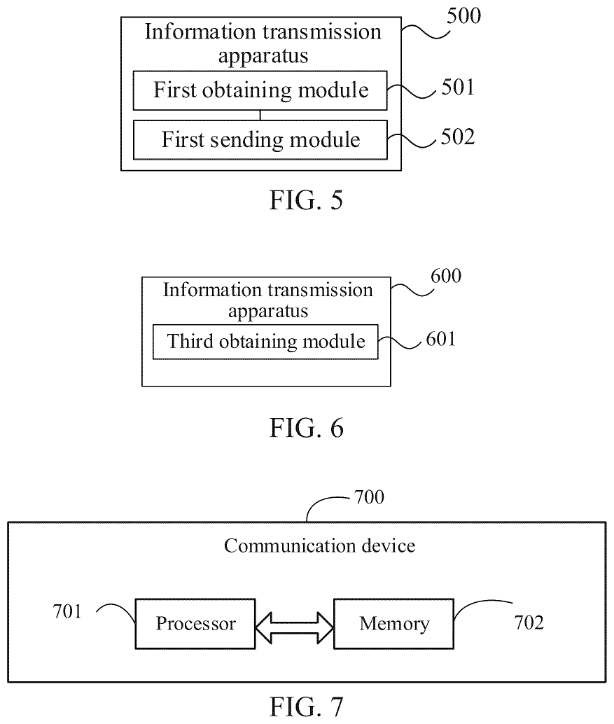

As shown in FIG. 5, an embodiment of this application provides an information transmission apparatus 500, applied to a first device, and including:
a first obtaining module 501, configured to measure a first signal to obtain a first result corresponding to each receiving unit, where the receiving unit includes a receiving antenna or a receiving channel, and the first signal includes at least one of a reference signal, a synchronization signal, a data signal, and a special signal; and
a first sending module 502, configured to send a first message, where the first message includes at least one first result satisfying a first condition or at least one second result satisfying a second condition, each second result is obtained by performing target operation processing on first results corresponding to two receiving units, and a target operation is a division operation or a conjugate multiplication operation.

Optionally, the first condition includes that sensing performance corresponding to the first result satisfies a preset condition;
and/or the second condition includes at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; and
feeder lengths of the at least two receiving antennas corresponding to the second result are consistent.

Optionally, the apparatus in this embodiment of this application further includes:
a first selection module, configured to select, from the first results, at least two target first results satisfying the first condition; and
a second obtaining module, configured to perform the target operation processing on the at least two target first results, to obtain the at least one second result.

Optionally, the apparatus in this embodiment of this application further includes:
a fourth obtaining module, configured to obtain a second message sent by a second device, where the second message includes at least one of the following:
a parameter of the first signal;
a first measurement quantity, where the first measurement quantity is associated with the first result;
a target operation being a division operation or a conjugate multiplication operation;
a first condition; and
a second condition.

Optionally, the sensing performance includes at least one of the following:
a power value of a sensed target-associated signal component;
a sensing signal-to-noise ratio (SNR);
a sensing signal-to-interference-plus-noise ratio (SINR);
a presence of a sensed target;
a quantity of existing sensed targets;
radar cross section (RCS) information of the sensed target;
spectral information of the sensed target;
a delay of at least one sensed target;
a distance of the at least one sensed target;
Doppler of the at least one sensed target;
a speed of the at least one sensed target; and
angle information of the at least one sensed target;
and/or the sensing performance satisfying the preset condition includes at least one of the following:
the power value of the sensed target-associated signal component satisfies a first threshold, or a power value of the sensed target-associated signal component is maximum;
a sensing SNR satisfies a second threshold, or the sensing SNR is maximum;
the sensing SINR satisfies a third threshold, or the sensing SINR is maximum;
at least Y sensed targets are detected;
a bitmap corresponding to a sensed target determined based on detection is consistent with a preset bitmap configured by a network side device;
the radar cross section (RCS) of the sensed target satisfies a third condition, or the RCS is maximum;
the spectral information of the sensed target satisfies a fourth condition, and
a first parameter of the sensed target satisfies a fifth condition, where the first parameter includes at least one of the following: delay, distance, Doppler, speed, and angle information,
where Y is a positive integer.

Optionally, the first message further includes at least one of the following:
a third result corresponding to a second measurement quantity obtained based on the second result;
a fourth result corresponding to a second measurement quantity obtained based on the first result;
label information corresponding to the first result;
label information corresponding to the second result;
label information corresponding to the third result; and
label information corresponding to the fourth result.

Optionally, the second measurement quantity includes at least one of the following:
a delay of a sensed target;
Doppler of the sensed target;
angle information of the sensed target;
strength of a sensing signal;
a distance of the sensed target;
a speed of the sensed target;
an orientation of the sensed target;
a spatial position of the sensed target;
an acceleration of the sensed target;
a presence of a sensed target;
at least one of trajectories, actions, expressions, vital signs, a quantity, and imaging results of sensed targets;
weather information;
air quality; and
at least one of a shape, a material, and an ingredient of the sensed target.

Optionally, the first measurement quantity includes at least one of the following:
a result of a frequency-domain channel response;
an amplitude of the frequency-domain channel response;
a phase of the frequency-domain channel response;
I channel data of the frequency-domain channel response;
Q channel data of the frequency-domain channel response; and
an operation result of the I channel data and the Q channel data.

Optionally, the label information includes at least one of the following:
sensing signal identification information;
sensing measurement configuration identification information;
sensing service information;
data subscription ID information;
measurement quantity usage information;
time information;
sensing node information;
sensing link information;
measurement quantity description information; and
measurement quantity indicator information.

Optionally, the parameter of the first signal includes at least one of the following:
a waveform type;
a subcarrier interval;
a guard interval;
a bandwidth;
a burst duration;
a time domain interval;
a signal sending power;
a signal format;
a signal direction;
a time resource;
a frequency resource;
a quasi co-location (QCL) relationship; and
antenna configuration information of a sensing node.

In embodiments of this application, the first device measures the first signal to obtain a first result corresponding to each receiving unit. The first device sends a first message. The first message includes at least one first result satisfying a first condition or at least one second result satisfying a second condition. Each second result is obtained by performing target operation processing on first results corresponding to two receiving units. In other words, in embodiments of this application, after the first result corresponding to each receiving unit is obtained, not all of the first results of the receiving units are reported, but the first result satisfying the second condition is reported, or the second result obtained based on the first result and satisfying the first condition is reported, so that the second device eliminates impact of the random phase fluctuations of the plurality of receiving antennas based on the second result or the first result, which greatly reduces reporting overheads of the first device.

As shown in FIG. 6, an embodiment of this application further provides an information transmission apparatus 600, applied to a second device, and the apparatus including:
a third obtaining module 601, configured to obtain a first message, where the first message includes at least one first result satisfying a first condition or at least one second result satisfying a second condition, each second result is obtained by performing target operation processing on first results corresponding to two receiving units, and a target operation is a division operation or a conjugate multiplication operation.

Optionally, the first condition includes that sensing performance corresponding to the first result satisfies a preset condition;
and/or the second condition includes at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; and
feeder lengths of the at least two receiving antennas corresponding to the second result are consistent.

Optionally, the apparatus in this embodiment of this application further includes:
a fourth obtaining module, configured to obtain a sensing result based on the first message;
or a second sending module, configured to send the first message to a third device.

Optionally, the fourth obtaining module includes:
a first processing submodule, configured to perform the target operation processing on at least two first results in the first message, to obtain at least one second result; and
a first obtaining submodule, configured to obtain a sensing result based on the second result.

Optionally, the apparatus in this embodiment of this application further includes:
a third sending module, configured to send a second message.

The second message includes at least one of the following:
a parameter of the first signal;
a first measurement quantity;
a target operation being a division operation or a conjugate multiplication operation;
a first condition; and
a second condition.

In embodiments of this application, the second device obtains a first message. The first message includes at least one first result satisfying a first condition or at least one second result satisfying a second condition. Each second result is obtained by performing target operation processing on first results corresponding to two receiving units. A target operation is a division operation or a conjugate multiplication operation. In other words, in embodiments of this application, the second device only obtains at least one first result satisfying a first condition or at least one second result satisfying a second condition, rather than obtaining the first result or the second result of each receiving unit, thereby greatly reducing reporting overheads of the first device.

The information transmission apparatus in embodiments of this application may be an electronic device, for example, an electronic device having an operating system, or may be a component in the electronic device, for example, an integrated circuit or a chip. The electronic device may be a terminal, or may be another device other than the terminal. For example, the terminal may include but is not limited to the above listed type of the terminal 11, and the another device may be a server, a network attached storage (NAS), or the like. This is not specifically limited in embodiments of this application.

The information transmission apparatus provided in embodiments of this application can implement each process implemented in the method embodiment of FIG. 2 to FIG. 4, and achieve the same technical effect. To avoid repetition, details are not described herein again.

Optionally, as shown in FIG. 7, an embodiment of this application further provides a communication device 700, including a processor 701 and a memory 702. The memory 702 stores a program or an instruction executable in the processor 701. For example, when the communication device 700 is a first device, the program or the instruction, when executed by the processor 701, implements the steps of embodiments of the foregoing information transmission method performed by the foregoing first device, and can achieve the same technical effect. When the communication device 700 is a second device, the program or the instruction, when executed by the processor 701, implements the steps of embodiments of the information transmission method performed by the foregoing second device, and can achieve the same technical effect. To avoid repetition, details are not described herein again.

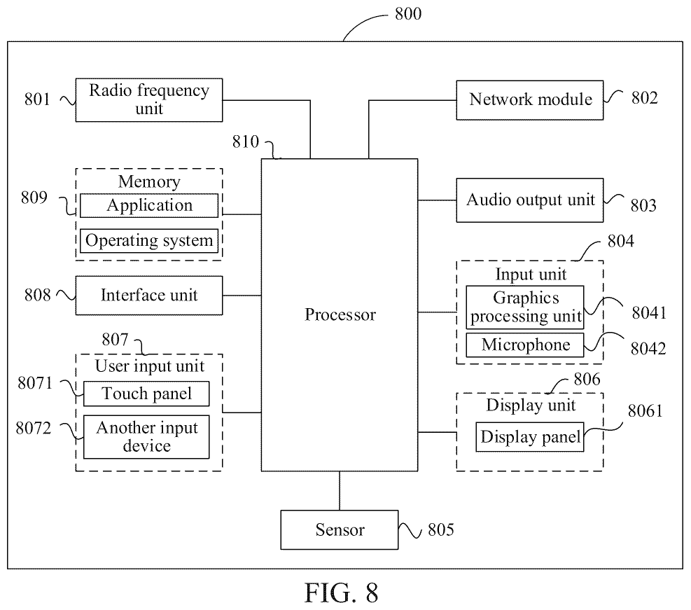

An embodiment of this application further provides a terminal, including a processor and a communication interface. The processor is configured to measure a first signal to obtain a first result corresponding to each receiving unit. The receiving unit includes a receiving antenna or a receiving channel. The first signal includes at least one of a reference signal, a synchronization signal, a data signal, and a special signal. The communication interface is configured to send a first message. The first message includes at least one first result satisfying a first condition or at least one second result satisfying a second condition. Each second result is obtained by performing target operation processing on first results corresponding to two receiving units. A target operation is a division operation or a conjugate multiplication operation. Alternatively, the communication interface is configured to obtain a first message. The first message includes at least one first result satisfying a first condition or at least one second result satisfying a second condition. Each second result is obtained by performing target operation processing on first results corresponding to two receiving units. A target operation is a division operation or a conjugate multiplication operation. The terminal embodiment corresponds to the foregoing method embodiment of the first device or the second device side. The implementation processes and manners of the foregoing method embodiments are applicable to the terminal embodiment, and can achieve the same technical effect. Specifically, FIG. 8 is a schematic diagram of a hardware structure of a terminal for implementing an embodiment of this application.

The terminal 800 includes but is not limited to at least some of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (for example, a battery) that supplies power to the components. The power supply may be logically connected to the processor 810 through a power management system, thereby implementing functions such as management of charging, discharging, and power consumption through the power management system. The terminal structure shown in FIG. 8 constitutes no limitation on the terminal, and the terminal may include more or fewer components than those shown in the figure, or some merged components, or different component arrangements. Details are not described herein again.

It should be noted that, in embodiments of this application, the input unit 804 may include a graphics processing unit (GPU) 8041 and a microphone 8042. The graphics processing unit 8041 processes image data of a static picture or a video obtained by an image capture apparatus (such as a camera) in a video capture mode or an image capture mode. The display unit 806 may include a display panel 8061. The display panel 8061 may be configured in a form such as a liquid crystal display or an organic light-emitting diode. The user input unit 807 includes at least one of a touch panel 8071 and another input device 8072. The touch panel 8071 is also referred to as a touch screen. The touch panel 8071 may include two parts: a touch detection apparatus and a touch controller. The another input device 8072 may include but is not limited to a physical keyboard, a function button (such as a volume control button or a power button), a trackball, a mouse, and a joystick. Details are not described herein again.

In embodiments of this application, the radio frequency unit 801 receives downlink data from a network side device, and then may transmit the data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area storing a program or an instruction and a second storage area storing data. The first storage area may store an operating system, an application or an instruction required for at least one function (such as a sound playback function or an image playback function), and the like. In addition, the memory 809 may include a volatile memory or a non-volatile memory, or the memory 809 may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 809 in embodiments of this application includes but is not limited to these and any other suitable types of memories.

The processor 810 may include one or more processing units. Optionally, an application processor and a modem processor is integrated into the processor 810. The application processor mainly processes operations related to an operating system, a user interface, an application, and the like. The modem processor mainly processes a wireless communication signal, such as a baseband processor. It may be understood that the foregoing modem processor may alternatively not be integrated into the processor 810.

In an embodiment of this application, the processor 810 is configured to measure a first signal to obtain a first result corresponding to each receiving unit. The receiving unit includes a receiving antenna or a receiving channel. The first signal includes at least one of a reference signal, a synchronization signal, a data signal, and a special signal. The radio frequency unit 801 is configured to send a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

Optionally, the first condition includes that the sensing performance corresponding to the first result satisfies a preset condition;
and/or the second condition includes at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; and
feeder lengths of the at least two receiving antennas corresponding to the second result are consistent.

Optionally, the processor 810 is further configured to:
select, from the first results, at least two target first results satisfying the first condition; and
perform the target operation processing on the at least two target first results, to obtain the at least one second result.

Optionally, the radio frequency unit 801 is further configured to obtain a second message sent by a second device, where the second message includes at least one of the following:
a parameter of the first signal;
a first measurement quantity, where the first measurement quantity is associated with the first result;
a target operation being a division operation or a conjugate multiplication operation;
a first condition; and
a second condition.

Optionally, the sensing performance includes at least one of the following:
a power value of a sensed target-associated signal component;
a sensing signal-to-noise ratio (SNR);
a sensing signal-to-interference-plus-noise ratio (SINR);
a presence of a sensed target;
a quantity of existing sensed targets;
radar cross section (RCS) information of the sensed target;
spectral information of the sensed target;
a delay of at least one sensed target;
a distance of the at least one sensed target;
Doppler of the at least one sensed target;
a speed of the at least one sensed target; and
angle information of the at least one sensed target;
and/or the sensing performance satisfying the preset condition includes at least one of the following:
the power value of the sensed target-associated signal component satisfies a first threshold, or a power value of the sensed target-associated signal component is maximum;
a sensing SNR satisfies a second threshold, or the sensing SNR is maximum;
the sensing SINR satisfies a third threshold, or the sensing SINR is maximum;
at least Y sensed targets are detected;
a bitmap corresponding to a sensed target determined based on detection is consistent with a preset bitmap configured by a network side device;
the radar cross section (RCS) of the sensed target satisfies a third condition, or the RCS is maximum;
the spectral information of the sensed target satisfies a fourth condition, and
a first parameter of the sensed target satisfies a fifth condition, where the first parameter includes at least one of the following: delay, distance, Doppler, speed, and angle information,
where Y is a positive integer.

Optionally, the first message further includes at least one of the following:
a third result corresponding to a second measurement quantity obtained based on the second result;
a fourth result corresponding to a second measurement quantity obtained based on the first result;
label information corresponding to the first result;
label information corresponding to the second result;
label information corresponding to the third result; and
label information corresponding to the fourth result.

Optionally, the second measurement quantity includes at least one of the following:
a delay of a sensed target;
Doppler of the sensed target;
angle information of the sensed target;
strength of a sensing signal;
a distance of the sensed target;
a speed of the sensed target;
an orientation of the sensed target;
a spatial position of the sensed target;
an acceleration of the sensed target;
a presence of a sensed target;
at least one of trajectories, actions, expressions, vital signs, a quantity, and imaging results of sensed targets;
weather information;
air quality; and
at least one of a shape, a material, and an ingredient of the sensed target.

Optionally, the first measurement quantity includes at least one of the following:
a result of a frequency-domain channel response;
an amplitude of the frequency-domain channel response;
a phase of the frequency-domain channel response;
I channel data of the frequency-domain channel response;
Q channel data of the frequency-domain channel response; and
an operation result of the I channel data and the Q channel data.

Optionally, the label information includes at least one of the following:
sensing signal identification information;
sensing measurement configuration identification information;
sensing service information;
data subscription ID information;
measurement quantity usage information;
time information;
sensing node information;
sensing link information;
measurement quantity description information; and
measurement quantity indicator information.

Optionally, the parameter of the first signal includes at least one of the following:
a waveform type;
a subcarrier interval;
a guard interval;
a bandwidth;
a burst duration;
a time domain interval;
a signal sending power;
a signal format;
a signal direction;
a time resource;
a frequency resource;
a quasi co-location (QCL) relationship; and
antenna configuration information of a sensing node.

Alternatively, in an embodiment of this application, the radio frequency unit 801 is configured to obtain a first message. The first message includes at least one first result satisfying a first condition or at least one second result satisfying a second condition. Each second result is obtained by performing target operation processing on first results corresponding to two receiving units. A target operation is a division operation or a conjugate multiplication operation.

Optionally, the first condition includes that sensing performance corresponding to the first result satisfies a preset condition;
and/or the second condition includes at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; and
feeder lengths of the at least two receiving antennas corresponding to the second result are consistent.

Optionally, the processor 810 is further configured to:
obtain a sensing result based on the first message.

Alternatively, the radio frequency unit 801 is further configured to: send the first message to a third device.

Optionally, the processor 810 is further configured to: perform target operation processing on at least two first results in the first message, to obtain at least one second result; and obtain a sensing result based on the second result.

Optionally, the radio frequency unit 801 is further configured to send a second message.

The second message includes at least one of the following:
a parameter of the first signal;
a first measurement quantity, where the first measurement quantity is associated with the first result;
a target operation being a division operation or a conjugate multiplication operation;
a first condition; and
a second condition.

In embodiments of this application, the first device measures the first signal to obtain a first result corresponding to each receiving unit. The first device sends a first message. The first message includes at least one first result satisfying a first condition or at least one second result satisfying a second condition. Each second result is obtained by performing target operation processing on first results corresponding to two receiving units. In other words, in embodiments of this application, after the first result corresponding to each receiving unit is obtained, not all of the first results of the receiving units are reported, but the first result satisfying the second condition is reported, or the second result obtained based on the first result and satisfying the first condition is reported, so that the second device eliminates impact of the random phase fluctuations of the plurality of receiving antennas based on the second result or the first result, which greatly reduces reporting overheads of the first device.

An embodiment of this application further provides a network side device, including a processor and a communication interface. The processor is configured to measure a first signal to obtain a first result corresponding to each receiving unit. The receiving unit includes a receiving antenna or a receiving channel. The first signal includes at least one of a reference signal, a synchronization signal, a data signal, and a special signal. The communication interface is configured to send a first message. The first message includes at least one first result satisfying a first condition or at least one second result satisfying a second condition. Each second result is obtained by performing target operation processing on first results corresponding to two receiving units. A target operation is a division operation or a conjugate multiplication operation. Alternatively, the communication interface is configured to obtain a first message. The first message includes at least one first result satisfying a first condition or at least one second result satisfying a second condition. Each second result is obtained by performing target operation processing on first results corresponding to two receiving units. A target operation is a division operation or a conjugate multiplication operation. The network side device embodiment corresponds to the foregoing method embodiment of the first device or the second device side. The implementation processes and implementations of the foregoing method embodiment are all applicable to the embodiment of the network side device, and can achieve the same technical effect.

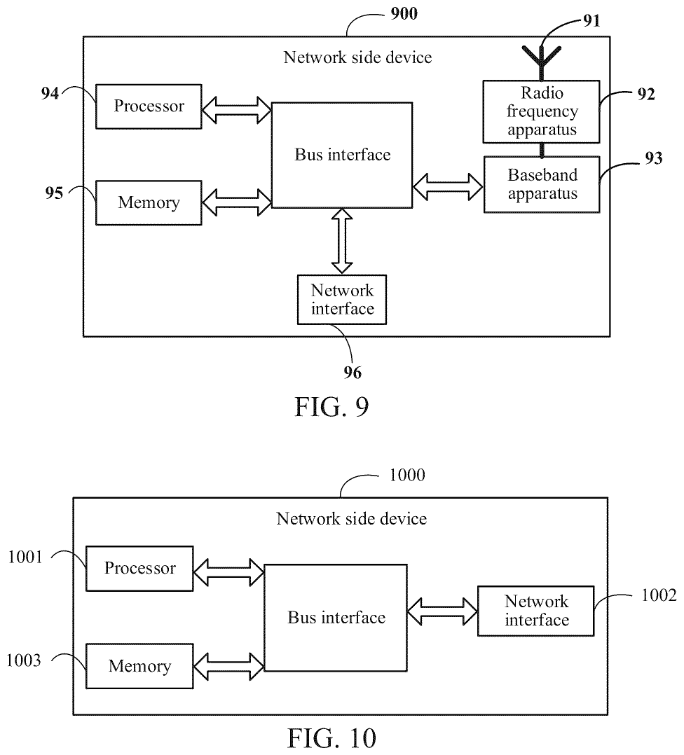

Specifically, an embodiment of this application further provides a network side device. As shown in FIG. 9, the network side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes to-be-sent information, and sends the processed to-be-sent information to the radio frequency apparatus 92. The radio frequency apparatus 92 processes the received information, and then sends the processed information through the antenna 91.

The method performed by the network side device in the foregoing embodiment may be implemented by the baseband apparatus 93. The baseband apparatus 93 includes a baseband processor.

The baseband apparatus 93 may include, for example, at least one baseband board. A plurality of chips are arranged on the baseband board, as shown in FIG. 9. One of the chips is for example a baseband processor, and is connected to the memory 95 through a bus interface to call a program in the memory 95 and perform the operations of the network device shown in the foregoing method embodiment.

The network side device may further include a network interface 96. The interface is, for example, a common public radio interface (CPRI).

Specifically, the network side device 900 in embodiments of this application further includes an instruction or a program stored in the memory 95 and executable by the processor 94. The processor 94 invokes the instruction or the program in the memory 95 to perform the method performed by each module shown in FIG. 5 or FIG. 6, and achieves the same technical effect. To avoid repetition, details are not described herein.

Specifically, an embodiment of this application further provides a network side device. As shown in FIG. 10, the network side device 1000 includes a processor 1001, a network interface 1002, and a memory 1003. The network interface 1002 is, for example, a common public radio interface (CPRI).

Specifically, the network side device 1000 in embodiments of this application further includes an instruction or a program stored in the memory 1003 and executable by the processor 1001. The processor 1001 invokes the instruction or the program in the memory 1003 to perform the method performed by each module shown in FIG. 5 or FIG. 6, and achieves the same technical effect. To avoid repetition, details are not described herein.

An embodiment of this application further provides a readable storage medium. The readable storage medium stores a program or an instruction. The program or the instruction, when executed by a processor, implements the processes of the foregoing embodiments of the information transmission method, and can achieve the same technical effect. To avoid repetition, details are not described herein again.

The processor is a processor in the terminal described in the foregoing embodiments. The readable storage medium includes a computer-readable storage medium, such as a computer read-only memory (ROM), a random access memory (RAM), a magnetic disk, or an optical disk.

An embodiment of this application further provides a chip. The chip includes a processor and a communication interface. The communication interface is coupled to the processor. The processor is configured to run a program or an instruction, to implement the processes of the foregoing embodiments of the information transmission method, and can achieve the same technical effect. To avoid repetition, details are not described herein again.

It should be understood that the chip mentioned in this embodiment of this application may further be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of embodiments of the foregoing information transmission method, and can achieve the same technical effect. To avoid repetition, details are not described herein again.

An embodiment of this application further provides an information transmission system, including a first device and a second device. The first device may be configured to perform the steps of the method for the first device side. The second device may be configured to perform the steps of the method for the second device side.

It should be noted that a term “comprise”, “include” or any other variant herein are intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in embodiments of this application is not limited to function execution in the order shown or discussed, and may further include function execution in a substantially simultaneous manner or in the opposite order based on the functions. For example, the described method may be performed in different order from the described order, and various steps may also be added, omitted, or combined. In addition, features described with reference to some examples may be combined in another example.

Through the descriptions of the foregoing implementations, a person skilled in the art may clearly learn that the method in the foregoing embodiments may be implemented by software with a necessary universal hardware platform, or may be implemented by hardware. However, in many cases, the software with a necessary universal hardware platform is a preferred implementation. Based on such an understanding, the technical solution of this application, in essence, or a part contributing to the prior art may be embodied in a form of a computer software product. The computer software product is stored in a storage medium (such as a ROM/RAM, a magnetic disk, or an optical disk), including several instructions for causing a terminal (such as a mobile phone, a computer, a server, an air conditioner, or a network device) to perform the method in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms without departing from the concept of this application and the protection scope of the claims. These forms fall within the protection of this application.

What is claimed is:

1. An information transmission method, comprising:
measuring, by a first device, a first signal to obtain a first result corresponding to each receiving unit, wherein the receiving unit comprises a receiving antenna or a receiving channel, and the first signal comprises at least one of a reference signal, a synchronization signal, a data signal, or a special signal; and
sending, by the first device, a first message, wherein the first message comprises at least one first result satisfying a first condition or at least one second result satisfying a second condition, each second result is obtained by performing target operation processing on first results corresponding to two receiving units, and a target operation is a division operation or a conjugate multiplication operation.

2. The method according to claim 1, wherein the first condition comprises that sensing performance corresponding to the first result satisfies a preset condition;
and/or the second condition comprises at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; or
feeder lengths of the at least two receiving antennas corresponding to the second result are consistent.

3. The method according to claim 1, further comprising:
selecting, from the first results, at least two target first results satisfying the first condition; and
performing the target operation processing on the at least two target first results, to obtain the at least one second result.

4. The method according to claim 1, further comprising:
obtaining, by the first device, a second message sent by a second device, wherein the second message comprises at least one of the following:
a parameter of the first signal;
a first measurement quantity, wherein the first measurement quantity is associated with the first result;
the target operation being a division operation or a conjugate multiplication operation;
the first condition; or
the second condition.

5. The method according to claim 2, wherein the sensing performance comprises at least one of the following:
a power value of a sensed target-associated signal component;
a sensing signal-to-noise ratio (SNR);
a sensing signal-to-interference-plus-noise ratio (SINR);
a presence of a sensed target;
a quantity of existing sensed targets;
radar cross section (RCS) information of the sensed target;
spectral information of the sensed target;
a delay of at least one sensed target;
a distance of the at least one sensed target;
Doppler of the at least one sensed target;
a speed of the at least one sensed target; or
angle information of the at least one sensed target;
and/or the sensing performance satisfying the preset condition comprises at least one of the following:
the power value of the sensed target-associated signal component satisfies a first threshold, or a power value of the sensed target-associated signal component is maximum;
the sensing SNR satisfies a second threshold, or the sensing SNR is maximum;
the sensing SINR satisfies a third threshold, or the sensing SINR is maximum;
at least Y sensed targets are detected;
a bitmap corresponding to a sensed target determined based on detection is consistent with a preset bitmap configured by a network side device;
the radar cross section (RCS) of the sensed target satisfies a third condition, or the RCS is maximum;
the spectral information of the sensed target satisfies a fourth condition; or
a first parameter of the sensed target satisfies a fifth condition, wherein the first parameter comprises at least one of the following: delay, distance, Doppler, speed, or angle information,
wherein Y is a positive integer.

6. The method according to claim 1, wherein the first message further comprises at least one of the following:
a third result corresponding to a second measurement quantity obtained based on the second result;
a fourth result corresponding to a second measurement quantity obtained based on the first result;
label information corresponding to the first result;
label information corresponding to the second result;
label information corresponding to the third result; or
label information corresponding to the fourth result.

7. The method according to claim 6, wherein the second measurement quantity comprises at least one of the following:
a delay of a sensed target;
Doppler of the sensed target;
angle information of the sensed target;
strength of a sensing signal;
a distance of the sensed target;
a speed of the sensed target;
an orientation of the sensed target;
a spatial position of the sensed target;
an acceleration of the sensed target;
a presence of a sensed target;
at least one of trajectories, actions, expressions, vital signs, a quantity, or imaging results of sensed targets;
weather information;
air quality; or
at least one of a shape, a material, or an ingredient of the sensed target.

8. The method according to claim 4, wherein the first measurement quantity comprises at least one of the following:
a result of a frequency-domain channel response;
an amplitude of the frequency-domain channel response;
a phase of the frequency-domain channel response;
I channel data of the frequency-domain channel response;
Q channel data of the frequency-domain channel response; or
an operation result of the I channel data and the Q channel data.

9. The method according to claim 6, wherein the label information comprises at least one of the following:
sensing signal identification information;
sensing measurement configuration identification information;
sensing service information;
data subscription ID information;
measurement quantity usage information;
time information;
sensing node information;
sensing link information;
measurement quantity description information; or
measurement quantity indicator information.

10. The method according to claim 4, wherein the parameter of the first signal comprises at least one of the following:
a waveform type;
a subcarrier interval;
a guard interval;
a bandwidth;
a burst duration;
a time domain interval;
a signal sending power;
a signal format;
a signal direction;
a time resource;
a frequency resource;
a quasi co-location (QCL) relationship; or
antenna configuration information of a sensing node.

11. An information transmission method, comprising:
obtaining, by a second device, a first message, wherein the first message comprises at least one first result satisfying a first condition or at least one second result satisfying a second condition, each second result is obtained by performing target operation processing on first results corresponding to two receiving units, and a target operation is a division operation or a conjugate multiplication operation.

12. The method according to claim 11, wherein the first condition comprises that sensing performance corresponding to the first result satisfies a preset condition;
and/or the second condition comprises at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; or
feeder lengths of the at least two receiving antennas corresponding to the second result are consistent.

13. The method according to claim 11, further comprising:
obtaining, by the second device, a sensing result based on the first message;
or sending, by the second device, the first message to a third device.

14. The method according to claim 13, wherein the obtaining, by the second device, a sensing result based on the first message comprises:
performing, by the second device, the target operation processing on at least two first results in the first message, to obtain at least one second result; and
obtaining a sensing result based on the second result.

15. The method according to claim 11, further comprising:
sending, by the second device, a second message, wherein
the second message comprises at least one of the following:
a parameter of the first signal;
a first measurement quantity, wherein the first measurement quantity is associated with the first result;
the target operation being a division operation or a conjugate multiplication operation;
the first condition; or
the second condition.

16. A communication device, comprising a processor and a memory, wherein the memory stores a program or an instruction executable in the processor, wherein the program or the instruction, when executed by the processor, causes the processor to perform:
measuring a first signal to obtain a first result corresponding to each receiving unit, wherein the receiving unit comprises a receiving antenna or a receiving channel, and the first signal comprises at least one of a reference signal, a synchronization signal, a data signal, or a special signal; and
sending a first message, wherein the first message comprises at least one first result satisfying a first condition or at least one second result satisfying a second condition, each second result is obtained by performing target operation processing on first results corresponding to two receiving units, and a target operation is a division operation or a conjugate multiplication operation.

17. The communication device according to claim 16, wherein the first condition comprises that sensing performance corresponding to the first result satisfies a preset condition;
and/or the second condition comprises at least one of the following:
sensing performance corresponding to the second result satisfies a preset condition;
at least two receiving antennas corresponding to the second result correspond to one transceiver or correspond to one analog-to-digital converter;
at least two receiving channels corresponding to the second result correspond to one transceiver or correspond to one analog-to-digital converter;
polarization characteristics of the at least two receiving antennas corresponding to the second result are consistent; or
feeder lengths of the at least two receiving antennas corresponding to the second result are consistent.

18. A communication device, comprising a processor and a memory, wherein the memory stores a program or an instruction executable in the processor, and the program or the instruction, when executed by the processor, implements the steps of the information transmission method according to claim 11.

19. A non-transitory readable storage medium, storing a program or an instruction, wherein the program or the instruction, when executed by a processor, implements the steps of the information transmission method according to claim 1.

20. A non-transitory readable storage medium, storing a program or an instruction, wherein the program or the instruction, when executed by a processor, implements the steps of the information transmission method according to claim 11.
